(19) United States
(12) Patent Application Publication
(10) Pub. No.: US 2007/0014924 A1
(43) Pub. Date: Jan. 18, 2007

(54) METHOD FOR COATING METAL SURFACES WITH CORROSION INHIBITING POLYMER LAYERS

(75) Inventors: Marc L.A.D. Mertens, Oss (NL); Rene van Schaik, Eindhoven (NL)

Correspondence Address: SENNIGER POWERS, ONE METROPOLITAN SQUARE, 16TH FLOOR, ST LOUIS, MO, 63102, US

(73) Assignee: ENTHONE INC., West Haven, CT (US)

(21) Appl. No.: 11/456,290

(22) Filed: Jul. 10, 2006

Related U.S. Application Data
(63) Continuation-in-part of application No. 11/279,696, filed on Apr. 13, 2006.

(30) Foreign Application Priority Data
Apr. 13, 2005 (EP) 05008022.5

(51) Int. Cl. B05D 3/12

(52) U.S. Cl. 427/327

(57) ABSTRACT

A method for coating a metal having a metal surface layer having an oxide layer thereon with a corrosion-inhibiting polymer resin layer. The method comprises contacting the surface of the metal with a pretreatment composition comprising an organophosphorus compound comprising phosphorus and an alkyl group capable of interacting with a plastic monomer resin or plastic polymer resin; and contacting the pretreated metal surface with a sealant composition comprising the plastic monomeric and/or polymeric resin.

### CROSS-REFERENCE TO RELATED APPLICATION

This application is a continuation-in-part application, and claims the benefit, of U.S. application Ser. No. 11/279,696, filed Apr. 13, 2006. Ser. No. 11/279,696 and this application claim priority of EP application 05008022.5, filed Apr. 13, 2005.

### FIELD OF THE INVENTION

The present invention relates to a method for coating metal surfaces with corrosion-inhibiting polymer layers.

### BACKGROUND OF THE INVENTION

Known methods for protecting metal surfaces from corrosion involve deposition of what is known as a conversion layer, which is a chromate material precipitated from an electrolytic solution containing chromium(III) and chromium(VI) salts, phosphate ions, and fluoride ions. The chromate conversion coating provides a rough surface which serves as an adhesion layer for adhering a protective polymer layer.

Environmental concerns, including the expenses involved in treating waste water containing hexavalent chromium ions, motivated the search for an adhesion layer which avoids the use of chromium. Alcoa is the assignee of several patents (see U.S. Pat. Nos. 6,030,710; 6,696,106; and 6,020,030) which disclose primer coatings comprising organophosphorus compounds which served as an adhesive layer between a metal surface and a protective polymer layer. The patents discuss their compounds in the context of protecting aluminum surfaces.

Zinc is commonly electrolytically plated over metal substrates, such as steel, as a sacrificial layer. Although this sacrificial layer is effective at protecting the underlying steel substrate for some time, zinc is a relatively reactive metal and subject to oxidation and corrosion. Corrosion products include zinc hydroxide, which is commonly known as “white rust.”

Accordingly, a need continues to exist for a primer composition which applies a strongly adhering layer between a metal surface and a protective polymer layer which can form an effective corrosion resistant barrier, while also avoiding the use of chromate conversion coatings.

### SUMMARY OF THE INVENTION

Among the various aspects of the present invention may be noted a process for coating a metal surface with a protective polymer layer, which inhibits corrosion of the metal surface.

Briefly, therefore, the present invention is directed to a method for coating a metal having a metal surface layer having an oxide layer thereon with a corrosion-inhibiting polymer resin layer, the method comprising contacting the surface of the metal with a primer composition to prime the metal surface, the primer composition comprising an organophosphorus compound, the organophosphorus compound selected from the group consisting of a compound comprising an alkene moiety and a phosphorus moiety, a polymer comprising a monomer derived from a compound comprising an alkene moiety and a phosphorus moiety, and a combination thereof; and contacting the primed metal surface with a sealant composition comprising a monomeric resin, polymeric resin, or a combination thereof.

Other objects and features of the invention will be in part apparent and in part pointed out hereinafter.

### DETAILED DESCRIPTION OF THE PREFERRED EMBODIMENT(S)

This application claims foreign priority from EP 05008022.5, the entirety of which is incorporated by reference.

In accordance with the present invention, a metal substrate is coated with a corrosion-inhibiting monomeric or polymeric resin which is applied on top of a primer coating formed from an organophosphorus compound. Organophosphorus compounds are capable of interacting with and chemically bonding to the surface of a metal substrate, particularly when the metal substrate comprises a surface oxide layer. Accordingly, the application of an organophosphorus compound to a metal surface having a surface oxide layer thereon is effective to form a corrosion-inhibiting layer on the metal surface.

The process of the present invention employs the organophosphorus compound undercoating as a primer layer for the additional application of a monomeric or polymeric resin layer which interacts with an organic moiety present in the organophosphorus compound. In other words, the organophosphorus compound comprises a phosphorus moiety which chemically bonds to the metal oxide surface of a metal substrate and additionally comprises an organic moiety capable of interacting with a monomeric and polymeric resin. The primer coating formed by the organophosphorus compound is capable of acting as a strongly adhesive layer between the metal surface and the monomeric and polymeric resin. The thickness of the primer layer is between about 0.1 μm and about 0.5 μm. The thickness of the overall primer/resin layer is between about 0.5 μm and about 1.5 μm, preferably between about 0.8 μm and about 1.2 μm.

Exemplary metal substrates for overcoating with the corrosion-inhibiting polymer layer of the present invention can include electrolytically plated zinc layers (plated from either acidic or alkaline zinc plating compositions), zinc alloys with Sn, Co, Ni, Mn, Fe wherein the minor component can be included between about 0.3 wt. % and about 1.5 wt. % (Co, Fe), between about 5 wt. % and about 15 wt. % (Ni), and about 5 wt. % and about 80 wt. % (Sn, Mn). Additional sacrificial metal layers for overcoating with the corrosion-inhibiting polymer layer of the present invention can include electrolytically plated aluminum and magnesium layers. The corrosion-inhibiting polymer layer may also be applied to metal substrates lacking a protective metal layer. These substrates can include iron, steel, and aluminum. Typically, the corrosion-inhibiting polymer layer comprises a permanent part of the sacrificial metal layer, which may be zinc, aluminum, or magnesium. With regard to those substrates which do not comprise a sacrificial metal layer, the corrosion-inhibiting polymer layer is typically applied only as a temporary coating, such as during shipping.

The primer composition of the present invention comprises an organophosphorus compound. The organophosphorus compound can be a compound comprising an alkene moiety and a phosphorus moiety, can be a polymer comprising a monomer derived from a compound comprising an alkene moiety and a phosphorus-containing moiety, or can be a combination thereof. The phosphorus moiety in the organophosphorus compound chemically reacts with oxide layer present on the surface of the metal substrate to form a primer coating over the metal substrate. The metal substrate typically has a passivating metal oxide layer. The phosphorus moiety of the organophosphorus compound contains phosphorus, which can be present in the compound in its 3+ or 5+ oxidation state, capable of forming chemical bonds with surface oxide present on the metal surface. Metal oxide on the surface reacts with organophosphorus compounds to form a chemical bond between the surface metal oxide and phosphorus. For example, the reaction between an exemplary surface metal oxide, such as zinc oxide, and an alkenyl phosphonate occurs as shown:
ZnOₓ₍ₛ₎+R—PO₃⁻_{(aq)}=>Zn—O—PO₂—R

Each phosphonate having the general structure shown in the above reaction can react with one, two, or three oxygen atoms on the surface of the surface metal layer. The reaction causes the phosphorus oxide compound to be chemically bonded to the surface metal oxide.

Exemplary organophosphorus compounds comprising an alkene moiety and a phosphorus moiety wherein the phosphorus is present in its 3+ oxidation state include alkenyl phosphonic acids, alkenyl phosphonate salts, and alkenyl phosphonate esters. Alkenyl phosphonic acids, alkenyl phosphonate salts, and alkenyl phosphonate esters compounds can have the following structure (I):

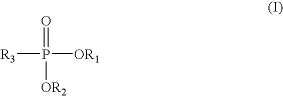

Wherein:

R₁ and R₂ are each independently hydrogen, a counter cation, or a substituted or unsubstituted alkyl group having from 1 carbon atoms to 12 carbon atoms; and

R₃ is a substituted or unsubstituted alkenyl group. Exemplary counter cations in the above structure (I) include lithium ions, sodium ions, potassium ions, and ammonium ions. Divalent cations are typically avoided because they render the organophosphorus compound less soluble in aqueous solution.

Exemplary organophosphorus compounds comprising an alkene moiety and a phosphorus moiety wherein the phosphorus is present in its 5+ oxidation state include alkenyl phosphoric acids, alkenyl phosphate salts, and alkenyl phosphate esters. Alkenyl phosphoric acids, alkenyl phosphate salts, and alkenyl phosphate esters compounds can have the following structure (II):

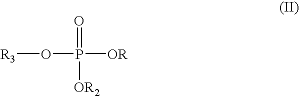

wherein R₁, R₂, and R₃ are defined as above in connection with structure (II).

Preferably, R₃ in the above structures (I) and (II) is an alkenyl group comprising between about 2 carbon atoms and about 12 carbon atoms, more preferably between about 2 carbon atoms and about 4 carbon atoms.

Preferably, the alkenyl phosphonate compound is vinyl phosphonic acid, a salt thereof, or an ester thereof and has the following structure (III):

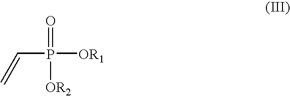

wherein R₁ and R₂ are each independently hydrogen, a counter cation, or a substituted or unsubstituted alkyl group having from 1 to 4 carbon atoms. The counter cations are as defined above in connection with structure (I). Vinyl phosphonic acid has the structure (IV):

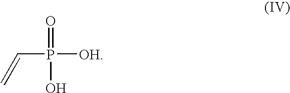

The organophosphorus compound can also be a polymer comprising a monomer derived from a compound comprising an alkene moiety and a phosphorus moiety wherein phosphorus in the phosphorus moiety can be present in an oxidation state of 3+ or 5+. The above-described organophosphorus compounds contain the ethene moiety (C═C) and are thus polymerizable. Accordingly, the organophosphorus compound of the present invention can be a polymer resulting from the polymerization of alkenyl phosphonic acids, alkenyl phosphonate salts, alkenyl phosphonate esters, alkenyl phosphoric acids, alkenyl phosphate salts, and alkenyl phosphate esters. The ethene moiety thus forms an alkyl polymer backbone.

For example, where the only monomer present is vinyl phosphonic acid, vinyl phosphonate salt, and/or vinyl phosphonate ester, the polymer can have the structure (V):

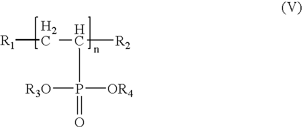

wherein:

R₁ and R₂ are either an initiating moiety selected from the group consisting of hydrogen, alkyl, ethoxyalkyl, propoxy alkyl, and hydroxyl or a terminating moiety selected from the group consisting of hydrogen, hydroxyl, carboxylate, amino, or imino, such that when R₁ is the initiating moiety, R₂ is the terminating moiety and when R₂ is the initiating moiety, R₁ is the terminating moiety;

R₃ and R₄ are each independently hydrogen, a counter cation, or a substituted or unsubstituted alkyl group having from 1 to 12 carbon atoms preferably between 2 carbon atoms and 4 carbon atoms; and n can be, for example, between about 100 and about 400, such as about 200. Preferably, the initiating and termination moieties can be hydrogen, a hydroxyl group, or a carboxylate group. The polymer can have a molecular weight between about 15,000 g/mol and about 40,000 g/mol. Exemplary counter cations in the above structure (V) include lithium ions, sodium ions, potassium ions, and ammonium ions. Vinyl phosphonic acid polymers are available from Rhodia.

The polymer can also include a second monomer which co-polymerizes with the alkenyl phosphonic acids, alkenyl phosphonate salts, alkenyl phosphonate esters, alkenyl phosphoric acids, alkenyl phosphate salts, and alkenyl phosphate esters. The polymer can be arranged in block, random, or alternating configuration.

Preferably, the second monomer has a carboxylate moiety. The carboxylate moiety is useful as an extra complexing group for metal ions and acts as a pH buffer on the metal surface. A co-polymer of vinyl phosphonic acid, ester, or salt and another monomer comprising a carboxylate moiety can have the structure (VI):

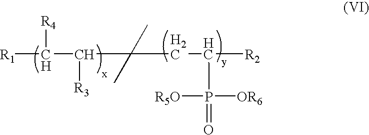

wherein:

R₁ and R₂ are either an initiating moiety selected from the group consisting of hydrogen, alkyl, ethoxyalkyl, propoxy alkyl, and hydroxyl or a terminating moiety selected from the group consisting of hydrogen, hydroxyl, and carboxyl, such that when R₁ is the initiating moiety, R₂ is the terminating moiety and when R₂ is the initiating moiety, R₁ is the terminating moiety;

R₃ and R₄ are each independently hydrogen, a carboxylate moiety, or an alkyl carboxylate moiety, and at least one of R₃ and R₄ comprises a carboxylate moiety;

R₅ and R₆ are each independently hydrogen, a counter cation, or a substituted or unsubstituted alkyl group having from 1 to 4 carbon atoms;

x and y represent the relative mole amounts of each monomer in the copolymer in a ratio of x to y between about 1:4 and about 4:1. Preferably, the initiating and terminating groups are hydrogen, hydroxyl, or carboxylate. Preferably, the ratio of x to y is between about 1:3 and about 3:1. The polymer can have a molecular weight between about 15,000 g/mol and about 100,000 g/mol, more preferably between about 20,000 g/mol and about 40,000 g/mol. Preferably, the co-polymer is in the random configuration.

An exemplary co-polymer of the above structure comprising one carboxylate moiety in the second monomer repeat unit, i.e., a co-polymer of acrylic acid and vinyl phosphoric acid, has the structure (VII):

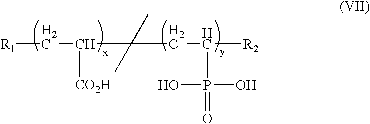

wherein x and y represent the relative mole amounts of each monomer in the copolymer. Preferably, the ratio of x to y is between about 4:1 and about 1:4, more preferably between about 3:1 and about 1:3, such as about 7:3. The polymer can have a molecular weight between about 30,000 g/mole and about 90,000 g/mol, more preferably between about 40,000 g/mol and about 50,000 g/mol. This polymer can be random or alternating, preferably alternating.

Another exemplary co-polymer of the above structure comprising two carboxylate moiety in the second monomer repeat unit, i.e., a co-polymer of fumaric acid and vinyl phosphoric acid, has the structure (VIII):

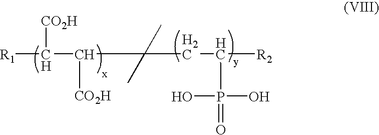

wherein x and y represent the relative mole amounts of each monomer in the copolymer. Preferably, the ratio of x to y is between about 4:1 and about 1:4. More preferably, the ratio of x to y is between about 3:4 and about 5:4. The polymer can have a molecular weight between about 20,000 g/mol and about 80,000 g/mol, more preferably between about 25,000 g/mol and about 45,000 g/mol. This polymer can be random or alternating, preferably alternating.

The organophosphorus compound is added to the primer composition of the present invention at a concentration between about 0.5% (w/v) and about 20% (w/v), preferably between about 1% (w/v) and about 3% (w/v), more preferably between about 2% (w/v) and about 2.5% (w/v). The organophosphorus compound is added to the composition in at least about 5 g/L to ensure a sufficient rate of monolayer coverage, while the concentration is typically below about 200 g/L because organophosphorus solutions are typically commercially available at concentrations no greater than about 200 g/L. In a preferred composition, the compound is polyvinylphosphonic acid.

Preferably, the pH of the primer composition is between about 1.5 and about 4, such as about 2. For pH adjustment, acids such as phosphoric acid, sulfuric acid, hydrochloric acid, nitric acid, and acetic acid and bases such as sodium hydroxide, potassium hydroxide, lithium hydroxide, organic amines, or ammonia are applicable.

The sealant composition of the present invention comprises a monomeric and/or a polymeric resin. Exemplary resins applicable for forming a protective polymer layer over the primer coating deposited by the primer composition include polyethylene wax, polyacrylate, polyamine, polyamide, urethane, polyurethane, polyether, polyester, polysilicate, and combinations thereof. As stated above, the organophosphorus compound comprises an organic moiety, which may be an alkenyl group or an alkyl group derived from the polymerization of the alkenyl group. The alkyl group can be derivatized with free carboxylate moieties. Thus, the organophosphorus compound can comprise reactive free alkenyl groups and reactive free carboxylate groups. These free reactive groups are capable of interacting with and in some cases bonding to the monomeric resin and polymeric resin materials described above. Accordingly, the organophosphorus compounds, which are chemically bonded to the metal surface layer through P—O bonds and chemically bonded to the resins through carboxylate or alkenyl groups, act as an adhesive layer between the resin and the metal surface layer.

The sealant composition comprises the monomeric resin or polymeric resin in a concentration between about 2% (w/v) and about 20% (w/v), preferably between about 8% (w/v) and about 10% (w/v), such as about 10% (w/v). To assist in solubilization of the monomeric resin or polymeric resin in aqueous solvent, the composition further comprises surfactants such as anionic (tensioactive) dispersants. The pH of the sealant composition is preferably between about 7 and about 11, more preferably between about 8.5 and about 9.5, such as about 9.2. For pH adjustment, organic acids such as acetic acid and bases such as sodium hydroxide and organic amines are applicable.

Exemplary sealant compositions are shown in the following table:

| Resin | Resin | | Surfactant | |
|---|---|---|---|---|
| Material | Concentration | Surfactant(s) | Concentration | pH |
| Polyethylene | 10% solids | Akylsulfonate | 0.1% | 9.2 |
| wax | | dispersant | | |
| ENSEAL ® 26 | 9.8% solids | Akylsulfonate | 0.1% | 9.2 |
| ENSEAL ® 21 | 9.6% solids | Sulfonated | 0.2% | 9.2 |
| | | Napthylphenol | | |
| | | condensate | | |
| ENSEAL ® 36 | 10% solids | none | — | 9.0 |

In practicing the method of the present invention, a metal substrate, such as steel, which has been plated with a zinc layer, is coated with a protective polymer layer. Accordingly, the process involves the following steps:

Pretreating the surface

Rinsing

Electrolytic zinc plating from an alkaline electrolytic zinc plating bath

Rinsing

Exposure to a primer composition

Drying or short water rinse

Exposure to a sealant composition

Drying.

In the first step, a metal substrate, which may be steel, is treated prior to alkaline electrolytic zinc plating. The pre-treatment involves immersion in an electrolytic cleaner (such as ENPREP® 223, available from Enthone Inc.) at 70° C. with an applied anodic current of 2-15 A/dm².

Following a water rinse, the pre-treated metal substrate is exposed to a zinc or zinc alloy electrolytic plating bath. Zinc electrolytic plating baths can have the following components:
i. A source of zinc ion such as solid zinc (which may be zinc chloride) in the form of zinc plates, zinc rods, or zinc particles in an basket in a so-called dissolution compartment sufficient to provide a concentration of zinc ion between about 10 g/L and about 20 g/L
ii. NaOH present in a concentration between about 110 g/L and about 180 g/L, such that a ratio NaOH:Zn can be between about 13:1 to about 10:1
iii. Grain refiners, brighteners, and other additives, such as those present in Enthobrite® NCZ Dimension A (10 mL/L to 20 mL/L), Enthobrite® NCZ Dimension B (0.1 mL/L to 5 mL/L), Enthobrite® NCZ C (1 mL/L to 5 mL/L), and Enthobrite® NCZ Conditioner (all available from Enthone Inc., West Haven, Conn.)
iv. Bath soluble polymer such as one described in U.S. Pat. No. 5,435,898, sold under the trade name MIRAPOL® WT, CAS No. 68555-36-2, available from Rhone-Poulenc (about 0.5 g/L to about 3 g/L).

Enthobrite® zinc plating bath is available from Enthone Inc. (West Haven, Conn.)

Plating equipment comprises an electrolytic plating tank which holds electrolytic plating solution and which is made of a suitable material such as plastic or other material inert to the electrolytic plating solution. A cathode, which may be steel, is horizontally or vertically disposed at the upper part of the tank.

The cathode substrate and anode are electrically connected by wiring and, respectively, to a rectifier (power supply). The cathode substrate for direct or pulse current has a net negative charge so that metal ions in the solution are reduced at the cathode substrate forming plated metal on the cathode surface. An oxidation reaction takes place at the anode. The cathode and anode may be horizontally or vertically disposed in the tank.

During operation of the electrolytic plating system, metal is plated on the surface of a cathode substrate when the rectifier is energized. A pulse current, direct current, reverse periodic current, or other suitable current may be employed. Preferably, plating is carried out by means of direct current. The temperature of the electrolytic solution may be maintained using a heater/cooler whereby electrolytic solution is removed from the holding tank and flows through the heater/cooler and then is recycled to the holding tank.

Electrolysis conditions such as electric current concentration, applied voltage, electric current density, and electrolytic solution temperature are essentially the same as those in conventional electrolytic plating methods. For example, the bath temperature is typically about room temperature such as about 20-27° C., but may be at elevated temperatures up to about 40° C. or higher. The electrical current density is typically up to about 100 mA/cm², typically about 2 mA/cm² to about 60 mA/cm². It is preferred to use an anode to cathode ratio of about 1:1, but this may also vary widely from about 1:4 to 4:1. The process also uses mixing in the electrolytic plating tank which may be supplied by agitation or preferably by the circulating flow of recycled electrolytic solution through the tank. The flow through the electrolytic plating tank provides a typical residence time of electrolytic solution in the tank of less than about 1 minute, more typically less than 30 seconds, e.g., 10-20 seconds.

Following electrolytic plating, the zinc-plated metal substrate can be rinsed and then exposed to a primer composition, with components as described above. Exposure can be by any method such as by immersion, flow, or spray with the provision that the exposure method is adequate to allow sufficient time for the organophosphorus compound to react with and bond to oxides present on the zinc surface layer. Specific compositions and conditions for exposure are shown in the Examples below.

Following exposure to the primer composition, the metal substrate having organophosphorus compound chemically bonded onto the surface is dried in an oven. The treated substrates are then dried. The dried substrate is then exposed to a sealant composition, with components as described above. Exposure can be by any method such as by immersion, flow, or spray with the provision that the exposure method is sufficient to allow the monomeric and/or polymeric resin to interact with and bond to the organophosphorus compound bonded to oxides present on the zinc surface layer. For example, the substrate can be dipped in the resin solution for 30 seconds at room temperature with no agitation. Adhesion is thought to be by van der Waal's and hydrogen bonding forces. In some cases, dehydration reactions between the resin and primer coating material can result in stronger covalent ether and ester linkages. Following exposure to the sealant composition, the metal substrate having a protective polymer layer on the surface is dried in an oven.

According to the above described method, a strongly adhering protective polymer layer can be deposited onto the surface of a metal substrate providing it with excellent corrosion inhibiting properties.

The following examples further illustrate the present invention.

### EXAMPLE 1

### Primer Composition Comprising a Co-polymer of Acrylic Acid and Vinyl Phosphoric Acid

A primer composition was prepared by adding an organophosphorus compound having the following structure to an aqueous solution:

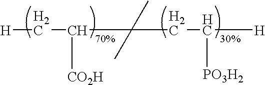

The acrylic acid/vinyl phosphoric acid co-polymer had a molecular weight of approximately 40,000 g/mol (random copolymer available from Rhodia), and the co-polymer was added in a concentration of 2% wt. by vol. The pH of the primer composition was adjusted to about 2 using sodium hydroxide and phosphoric acid.

### EXAMPLE 2

### Sealant Composition Comprising Polyethylene Wax

A sealant composition was prepared by adding polyethylene wax (10% wt. by vol.) using anionic tensides to emulsify and solubilize the polyethylene wax. The pH of the primer composition was adjusted to about 9.2 using sodium hydroxide and acetic acid.

### EXAMPLE 3

### Corrosion-Protection of Zinc Metal Plated Substrate

The primer composition of Example 1 and the sealant composition of Example 2 were used to coat a zinc-coated metal substrate with a corrosion-inhibiting polymer resin layer.

The metal substrate was steel. This substrate was plated with a zinc layer (10 micron average thickness) using Enthobrite® NCZ Dimension, available from Enthone Inc. (West Haven, Conn.) according to the datasheet conditions provided by Enthone.

After a cascade water rinse (twice, one minute each time), the zinc-plated substrate was immersed in the primer composition of Example 1 at room temperature for 30 seconds with mild agitation.

The zinc-plated substrate with a primer coating thereon was dried in an oven (10 minutes, 80° C.) and then immersed in the sealant solution of Example 2 at room temperature for 30 seconds.

The zinc-plated substrate having a polymeric layer coating thereon was dried in an oven (10 minutes, 80° C.).

A zinc-plated steel substrate having a polymer layer thereon and a control zinc-plated steel substrate having no polymer layer were tested according to standard corrosion test ASTM B117 to determine that the polymer was effective to inhibit corrosion of the zinc deposit. The zinc layer without the primer coating exhibited first white corrosion within 5 to 10 minutes in the salt spray climate. Conversely, the zinc-plated steel substrate having a polymer layer thereon withstood salt spray for 48 to 100 hours before exhibiting first white corrosion.

In view of the above, it will be seen that the several objects of the invention are achieved and other advantageous results attained.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense. The scope of invention is defined by the appended claims and modifications to the embodiments above may be made that do not depart from the scope of the invention.

What is claimed is:

1. A method for coating a metal having a metal surface layer having an oxide layer thereon with a corrosion-inhibiting polymer resin layer, the method comprising:
contacting the surface of the metal with a primer composition to prime the metal surface, the primer composition comprising an organophosphorus compound, the organophosphorus compound selected from the group consisting of a compound comprising an alkene moiety and a phosphorus moiety, a polymer comprising a monomer derived from a compound comprising an alkene moiety and a phosphorus moiety, and a combination thereof; and
contacting the primed metal surface with a sealant composition comprising a monomeric resin, polymeric resin, or a combination thereof.

2. The method of claim 1 wherein the metal surface layer is selected from the group consisting of zinc or an alloy thereof.

3. The method of claim 1 wherein the organophosphorus compound is the compound comprising the alkene moiety and the phosphorus moiety wherein phosphorus in the phosphorus moiety has an oxidation state of +3.

4. The method of claim 3 wherein the organophosphorus compound has the structure: 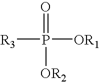
wherein
R₁ and R₂ are each independently hydrogen, a counter cation, or a substituted or unsubstituted alkyl group having from 1 to 12 carbon atoms; and
R₃ is a substituted or unsubstituted alkenyl group.

5. The method of claim 4 wherein the organophosphorus compound has the structure: 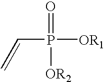
wherein R₁ and R₂ are each independently hydrogen, a counter cation, or a substituted or unsubstituted alkyl group having from 1 to 12 carbon atoms.

6. The method of claim 5 wherein the organophosphorus compound is vinyl phosphonic acid.

7. The method of claim 1 wherein the organophosphorus compound is the polymer comprising the monomer derived from the compound comprising the alkene moiety and the phosphorus moiety wherein phosphorus in the phosphorus moiety has an oxidation state of +3.

8. The method of claim 7 wherein organophosphorus compound has the structure: 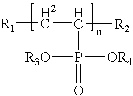
wherein:
R₁ and R₂ are either an initiating moiety selected from the group consisting of hydrogen, alkyl, ethoxyalkyl, propoxy alkyl, and hydroxyl or a terminating moiety selected from the group consisting of hydrogen, hydroxyl, carboxylate, amino, and imino, such that when R₁ is the initiating moiety, R₂ is the terminating moiety and when R₂ is the initiating moiety, R₁ is the terminating moiety;
R₃ and R₄ are each independently hydrogen, a counter cation, or a substituted or unsubstituted alkyl group having from 1 to 12 carbon atoms; and
n is between about 100 and about 400.

9. The method of claim 8 wherein R₃ and R₄ are hydrogen, and n is about 200.

10. The method of claim 7 wherein the polymer comprises a second monomer.

11. The method of claim 10 wherein the second monomer comprises a carboxylate moiety.

12. The method of claim 11 wherein the organophosphorus compound has the structure: 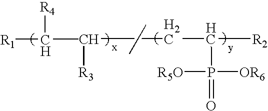
wherein:
R₁ and R₂ are either an initiating moiety selected from the group consisting of hydrogen, alkyl, ethoxyalkyl, propoxy alkyl, and hydroxyl or a terminating moiety selected from the group consisting of hydrogen, hydroxyl, and carboxylate, such that when R₁ is the initiating moiety, R₂ is the terminating moiety and when R₂ is the initiating moiety, R₁ is the terminating moiety;
R₃ and R₄ are each independently hydrogen, a carboxylate moiety, or an alkyl carboxylate moiety, and at least one of R₃ and R₄ comprises a carboxylate moiety;
R₅ and R₆ are each independently hydrogen, a counter cation, or a substituted or unsubstituted alkyl group having from 1 to 4 carbon atoms;
x and y represent the relative mole amounts of each monomer in the copolymer; and
a ratio of x to y is between about 1:4 and about 4:1.

13. The method of claim 12 wherein R₅ and R₆ are each hydrogen, and the ratio of x to y is about 7:3.

14. The method of claim 13 wherein R₃ and R₄ are each a carboxylate moiety.

15. The method of claim 1 wherein the monomeric resin or polymeric resin is selected from the group consisting of polyethylene wax, polyacrylate, polyamine, polyamide, urethane, polyurethane, polyether, polyester, polysilicate, and combinations thereof.
